(19) United States
(12) Patent Application Publication
(10) Pub. No.: US 2022/0027840 A1
(43) Pub. Date: Jan. 27, 2022

(54) System and Method for Identifying Items and Inventory Thereof

(71) Applicant: CHIEN WEN LI, Taichung City (TW)

(72) Inventor: CHIEN WEN LI, Taichung City (TW)

(21) Appl. No.: 17/381,166

(22) Filed: Jul. 20, 2021

(30) Foreign Application Priority Data
Jul. 22, 2020 (TW) 109124855

(51) Int. Cl. G06Q 10/08; G01G 23/365; G06F 40/177

(52) U.S. Cl. CPC G06Q 10/087; G06F 3/0482; G06F 40/177; G01G 23/365

(57) ABSTRACT

The present invention provides a system and method for identifying items and inventory thereof. The system includes a weight measuring device, an information processing device, a commodity weight table, an inventory storage table, and an access record. The weight measuring device carries and monitors the overall weight of all items. The information processing device is connected to the weight measuring device, so as to receive the weight output from the weight measuring device. The information processing device calculated the weight value of the item when it is accessed based on the weight value before and after the increase or decrease of the items, so that the user may add item information, or allow the system to actively compare the weight value with the commodity weight tables, the inventory storage table, and the access record, to screen out one or more items with closed weights for the users to choose, identify, and estimate the inventory.

### BACKGROUND OF THE PRESENT INVENTION

### Field of Invention

The present invention relates to a system and method for identifying items and inventory, in particular, to the system and method of identifying the item and inventory by comparing the weight value and the access record thereof when the item is accessed, and comparing the weight of the goods and the weight of the inventory item, so as to identify the item and estimate the inventory.

### Description of Related Arts

In order to understand the inventory status in real time, some inventors have proposed of utilizing camera shooting to identify items and count the inventory. Though this kind of technology is convenient, however it faced with bottlenecks, such as incomprehensibility, invisible, and non-transparent scenarios. For example, items such as new products, new packaging, items with no fixed appearances, items having outer bags or covers, and etc. are not only impossible to identify, but also inaccurate count on the inventory. Besides, for opaque containers, it also faces the problem of not being able to accurate identify the remaining inventory. Therefore, such prior technology may not be a good strategy for inventory management.

Besides, some inventors proposed a technology to analyze inventory status by weight, in which a weight measurement device is installed in the storage chamber, and when the article is placed on the weight measurement device, the measurement device will transmit the measured weight to the interface device provided outside the storage chamber. Then the user may record the name of the item through some input means. Although this technology can accurately catch the inventory status, however, due to the inability to automatically identify items and follow-up tracking of changes in the inventory, as a result, each time of add, retrieve, and restore requires the user to put the item on the weight measurement device and removed the item after measure, and also perform actions such as input, barcode scanning or editing. The whole operation is not only too complicated, but also almost the same as the steps of weighing the items outside the storage room and putting them back into the storage room.

In additional, some inventors also proposed by utilizing another technology of identifying items with electronic tags, supplemented by the dynamic value of weight to count the stock. This technology can indeed accurately identify and count items clearly, but the disadvantages are in addition to the high cost of construction and electronic tag. While an item is first time placed, it is necessary to enter the item information, print and paste the electronic labels, and etc., it will not be more convenient to utilize for those storage with frequent access and frequent changes in items, such as refrigerators. Moreover, for items that do not have electronic tags or unable to identify by electronic tags, they can only be categorized to a specific category on that particular item, and cannot record the correct information and storage volume, which is likely to cause a blind spots in the inventory management.

### SUMMARY OF THE PRESENT INVENTION

In view of this, the present invention provides a system and method for identifying items and inventory, which utilizes the weight value of the item when it is stored to compare with the weight value of the item, and then filters out one or more items with similar weights, and present them in text, pictures, images, sounds, and etc., for the users to operate or select by means of touch, voice, or tools such as mouse and keyboard, and etc. The users may add or edit item information and weight values to the item weight table, and the item weight table is stored at the client device, wherein the client device can be a variety of computer devices, smart home appliances, mobile devices, or wearable devices, such as computers, smart TVs, smart refrigerators, smart phones, tablets, smart bracelets or smart watches, and etc., wherein a client device is able to connect to the web server and share the item weight table, so as to allow the web server to collect and compile all item weight tables for the users to update; the item weight table can also be directly stored on the network server, and the client device can compare the item weight value directly or through the network to identify the item and estimate the stock of the item.

The present invention provides a system and method for identifying items and inventory, which utilizes the weight value of the item when it is taken to compare with the weight value of the inventory items, and then filter out one or more items with similar weight, and presents them in text, pictures, images, sounds, and etc., for the users to operate or select by means of touch, voice, or tools such as mouse and keyboard, and etc. The user can add or edit the item information and weight value to an inventory storage table, the inventory storage table is stored in the above-mentioned client device or web server for the client device to compare the weight value of the item directly or through the Internet to identify the item and estimate the item inventory.

The present invention further provides a system and method for identifying items and inventory, which utilizes the overall weight increase and access record, to list the items that have been taken out but not yet returned, and presented in the form of text, pictures, images, sounds, and etc., for the user to operate or select by means of touch, voice, or tools such as mouse and keyboard, and etc. The access record is stored in the above-mentioned client device or web server for the client device to compare the weight value of the item directly or through the Internet to track the change in the inventory of the items. The user may also set the return period or notification of each item to manage the item's life cycle or return reminder.

The present invention provides a system and method for identifying items and inventory, this system includes a weight measurement device, an information processing device, an item weight table, an inventory storage table, and an access record. The weight measurement device, information processing device, item weight table, inventory storage table, and access record may be partly or completely integrated into one, or be independent from each other through physical lines, Bluetooth or network connection. Here, the weight measurement device carries and monitors the overall weight of all items. The information processing device is connected with the weight measurement device to receive the weight output by the weight measurement device. The item weight table records common items or user-added or edited item information and weight values. The inventory storage table records the information and weight value of each item in the current inventory. The information processing device calculates the weight value of the item when it is accessed according to the weight obtained before and after the increase or decrease of an item, and compares with the item weight table and the inventory storage table based on the weight value and access record, and screen out one or more items of similar weight, and presented in the form of text, picture, image, sound, and etc., for the user to operate or select by means of touch, voice or other tools such as mouse and keyboard, and then update the item weight table, inventory storage table, and access record according to the items selected by the user so as for identifying the items and estimating item inventory.

The present inventory also provides a system and method for identifying items and inventory, which is suitable for tracking the life cycle of the inventory items, such as, changes in dynamic inventory such as access and storage. This system and method for identifying items and inventory is to actively list the items that have not been restored when the overall weight increases and there are still items in the access record that have been taken out and have not been restored, and presented in the form of text, pictures, images, sounds, and etc., for the user to operate or select with touch, voice, and etc., or tools such as mouse and keyboard, in view to operate or select, and update the inventory and access record after the user selects. In additional, it is possible to set a return period and reminder notice for each item to prevent used or discarded items from being listed in the list of unreturned items for a long time, and to prevent the items from being lost or damaged due to forgetting to return.

The present invention further provides a system and method for identifying items and inventory, which is suitable for continuously improving the ability of item identification. Firstly, this system and method for identifying items and inventory allows the users to add or edit item information, weight values, store into the inventory storage table, and then share through the link with a web server, wherein the web server will collects and processes the user-shared the inventory storage table, and compiled a summary table into the inventory storage table for all users to compare or update, so as to continuously improve the breadth and accuracy of item identification.

In an embodiment of the present invention, when adding an item and causing the overall weight of the system for identifying items and inventory increased, the weight measurement device and the information processing device will detect and recalculate the weight value of the item, compare with the weight value of each item in the inventory storage table to list items with similar weights, and then compare with the access record to list the items that have yet to restored, and let the user to select the items, which to update the item at item weight table, inventory storage table and access record. The users may add or edit the item information and weight values into the item weight table, or add or edit the item information and weight values to the inventory storage table. The users may also delete part of the data in the item weight table or the inventory storage table, in order to improve the comparison efficiency.

According to the previous embodiment, when an item is taken out from the storage chamber rendering the overall weight reduced, the weight measurement device and the information processing device detect and calculate the weight value of the item, compare it with the weight value of each item in the inventory storage table, filter out and list down the items with similar weights for the user to choose, then update the inventory storage table and access record according to the item selected by the user, and allow the user to edit or customize the item information by own.

In summary, the present invention utilizes the weight value and access record of the item when it is accessed, to compare, analyze, and identify the item and inventory, so as to greatly reduce the process of manually inputting, scanning the barcodes or sticking the electronic labels, as well as avoid the cost of building electronic label sensors and label usage costs. More importantly, it can also greatly improve the efficiency and provide more accurate inventory of each item.

In order to make the above objects, features, and advantages of the present invention more understandable, it further provides a detailed description of the preferred embodiments, in conjunction with the accompanying drawings as follows.

### BRIEF DESCRIPTION OF THE DRAWINGS

FIG. 1 is a block diagram of a system for identifying items and inventory according to an embodiment of the present invention.

FIG. 2 is a flowchart of a system and method for identifying items and inventory according to an embodiment of the present invention.

FIG. 3 is an architecture diagram of a system and method for identifying items and inventory according to an embodiment of the present invention.

FIG. 4 is a step diagram of a system and method for identifying items and inventory in an embodiment of the present invention.

According to the usual working method, various features and components in the figures are not drawn to scale, as the drawing method is to present the specific features and components related to the case in the best way. In addition, in different drawings, the same or similar element symbols are used to refer to similar elements/components.

### DETAILED DESCRIPTION OF THE PREFERRED EMBODIMENT

The following will explain the system and method for identifying items and inventory of the present invention through implementations. However, the embodiments of the present invention are not intended to limit the implementation of the present invention in any environment, application or method as described in the embodiments. Therefore, the description of the embodiments is only for the purpose of illustrating the present invention, rather than directly limiting the present invention. It should be noted that in the following embodiments and figures, elements not directly related to the present invention have been omitted and not shown.

Unless otherwise defined in this specification, the scientific and technical terms used here have the same meaning as understood and used by those with ordinary knowledge in the technical field of the case.

The following describes a system and method for identifying items and inventory according to embodiments of the present invention.

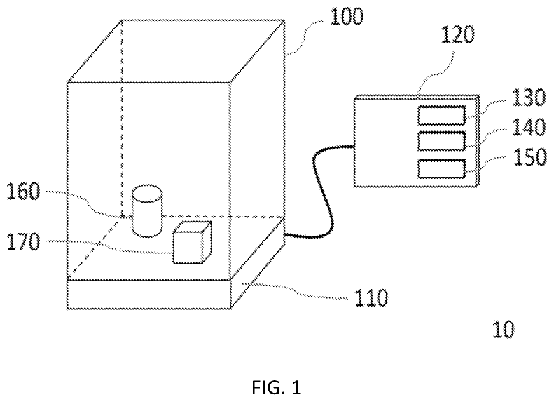

Refer to FIG. 1, it is a system block diagram of an item identification and inventory system according to an embodiment of the present invention. According to this embodiment, the system for identifying items and inventory 10 includes a storage chamber 100, and a weight measurement device 110 and an information processing device 120 disposed outside the storage chamber 100. The information processing device 120 has a dynamic database, which has an item weight table 130, an inventory storage table 140, an access record 150, and etc. The item 160 and the item 170 represent items placed in the storage chamber 100. In the actual implementation of the present invention, the weight measurement device 110, the information processing device 120, the item weight table 130, the inventory storage table 140, and the access record 150 may be partially or completely integrated into one, or be independent from one another, or be communicatively connected with one another through physical lines, Bluetooth or Internet. Furthermore, the existence of the storage chamber 100 is not necessarily required when the present invention is actually implemented; namely, the storage chamber 100 may be a closed space or an open space. In other words, the system of the present invention only needs to utilize the weight measurement device 110 to place an object and provide relevant information to the information processing device 120.

According to this embodiment, the weight measurement device 110 carries the storage chamber 100 and all the item stored inside the storage chamber 100, and measure the overall weight of the storage chamber 100 and these items. The information processing device 120 is connected with the weight measurement device 110, which receives the aforementioned overall weight, according to the weight obtained before and after the storage of an item, calculates the weight value of the item when it is accessed, and compares the weight value with the item weight table 130, the inventory storage table 140, and the access record 150, so as to filter out one or more items with similar weights for the user to choose, and then to update the item weight table 130, the inventory storage table 140, and access record 150 according to the items selected by the user so as for identifying the items and estimating item inventory.

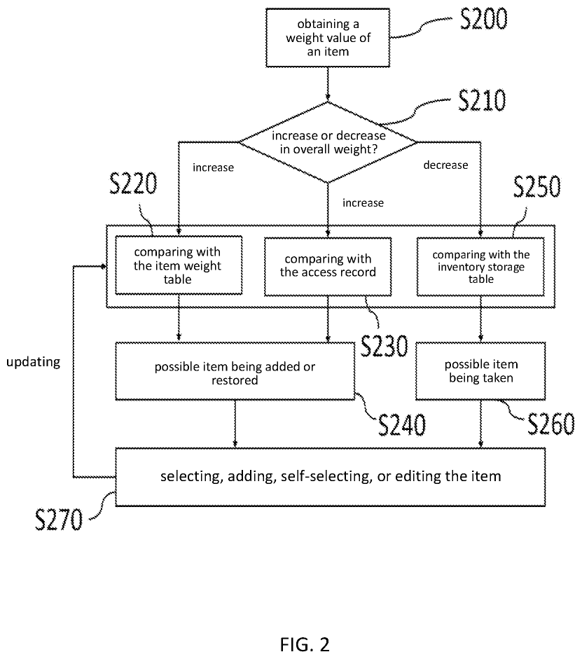

It is necessary to have an appropriate method in order to correctly identify items and continue to track the dynamic inventory changes, such as addition, retrieval, return, termination, and etc. and life cycles of each of the items. Refer to FIG. 2, it is a flowchart of a system and method for identifying items and inventory according to an embodiment of the present invention. According to this embodiment, placing an item in a specific area (such as the storage chamber 100 as illustrated in FIG. 1) causes change of the overall weight, so the system measures and calculates the total weight obtained before and after the item was stored; then estimates the weight value of the item when it is accessed (step S200); if the overall weight of the item is increased (step S210), compares the weight value of each item according to the weight value of the goods (the item weight table 130 as illustrated in FIG. 1) (step S220); then compares the records of the unreturned items in the access record (such as the access record 150 shown in FIG. 1) (step S230), wherein the storage time limit can be set for each item; judges that the item has been used up or discarded beyond time; deletes it from the record of unreturned items taken out; and eventually lists one or more items of similar weight according to the comparison result for the user to choose (step S240). Alternatively, the system also allows the user to select, add, or edit the item information containing the weight value and save it to the item weight table or inventory list. After the selecting, adding, self-selecting or editing by the user, the system will update the data base, including the item weight table, the inventory storage table, and the access record (step S270).

The following will further describe the flow of article retrieval according to the above embodiment, referring to FIG. 2. According to this embodiment, a certain item is taken out from a specific area (such as the storage chamber 100 as illustrated in FIG. 1), rendering change of the overall weight, so the system measures and calculates the overall weight of the item before and after the item is retrieved; and estimates the weight value of the item when it is accessed (step S200); if the item access cause a decrease in overall weight (step S210), compares the weight value of the item with the weight value of each item in the item inventory table (such as the item inventory table 140 shown in FIG. 1) (step S250); lists one or more items with similar weight, according to the comparison result, for the user to choose (step S260). Alternatively, the user may also select, add, or edit the item information containing the weight value and save it to the item weight table or inventory list, after the selecting, adding, self-selecting or editing by the user, the system will update the data base, including the inventory storage table and the access record (step S270).

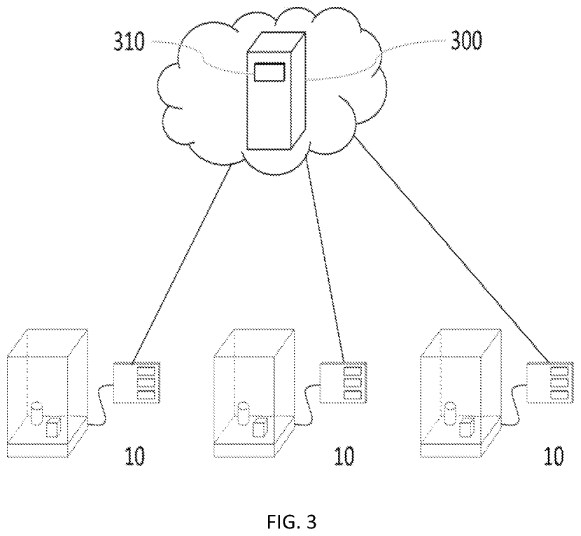

In addition to enable the identification of items and inventory system to continuously improve the breadth and accuracy of item identification, a good architecture design and method are required, referring to FIG. 3. It is an architecture diagram of a system and method for identifying items and inventory according to an embodiment of the present invention. According to this embodiment, a plurality of systems for identifying items and inventory 10 are connected with one another through a web server 300 through a network, and the web server 300 collects all item information added or edited by the systems for identifying items and inventory 10, processes it and consolidates it into a total item weight table 310. When a new item is added to the system for identifying items and inventory and the weight value of the item is obtained thereby, the weight value may not only be compared with the information of the system for identifying items and inventory 10, but also be compared with the total item weight table 310 through the network connection with the web server 300. Furthermore, it may also update the relevant information of the system for identifying items and inventory 10 through the total item weight table 310, so as to achieve the purpose of improving the identification of items and objects.

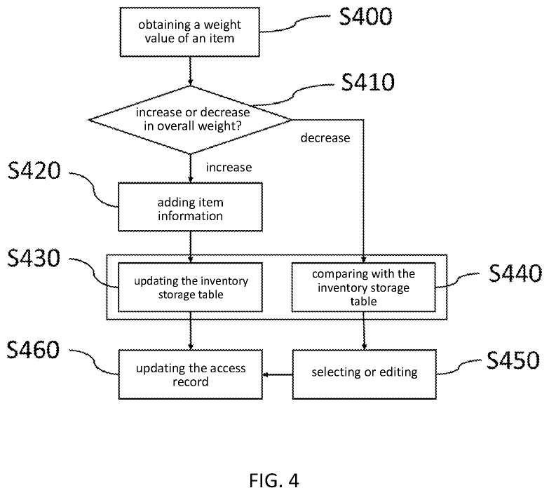

In addition, in order to make the application of the system for identifying items and inventory wider, the present invention also provides another utilization method. Refer to FIG. 4, it is a flowchart of a system and method for identifying items and inventory according to an embodiment of the present invention. According to this embodiment, putting an item into a specific area (such as the storage chamber 100 as illustrated in FIG. 1) causes change of the overall weight, so the system measures and calculates the overall weight of the item before and after the item is accessed, and then estimates the weight value of the item when it is accessed (step S400). If the access to the item causes the overall weight to increase (step S410), the user may input the item information (step S420) and update the inventory storage table with the item information and its weight value (step S430) and the same time access record will also be updated (step S460). On the other hand, taking out an item from a specific area (such as the storage chamber 100 as illustrated in FIG. 1) will cause the overall weight changed, so the system measures and calculates the total weight obtained before and after the item was accessed, and then estimates the weight value of the item when it is accessed (step S400), wherein if the access to the item causes the overall weight to decrease (step S410), the information or weight value of the item will be compared with the information or weight value of each item in the inventory storage table (step S440). After being selected or edited by the user (step S450), the access record will be updated accordingly (step S460).

In order to make the technology of the present invention more obvious and understandable, the following utilizes actual figures to provide detailed examples. Take a refrigerator as an example, the refrigerator is used as the storage chamber, an electronic scale is used as the weight measurement device, and an embedded system is used as an information processing device, in addition to an item weight table, inventory storage table, and access record.

When the electronic scale detects an increase in the overall weight of the items in the refrigerator, the embedded system will calculate the added weight value and the user may add item information, update the inventory storage table and access record, or compare the weight value with the item weight table in the following to filter and select items with similar weights.

| Brand | Product Name | Weight |
|---|---|---|
| Brand A | Pure Fresh Milk 2 L | 2100 g |
| Brand A | Juice Flavored Milk 1300 ml | 1365 g |
| Brand B | Beer 330 ml | 370 g |
| Brand A | Frozen Cabbage Dumplings | 2000 g |
| Brand C | Fresh Milk 1.89 L | 1955 g |
| Brand D | Cheese | 680 g |
| Brand D | Cheese Stick | 735 g |
| Brand C | Chili Sauce | 425 g |
| Brand E | Sugar Free Green Tea 4200 ml | 4320 g |

According to the comparison result of the differences of the weight values, it lists the following menu from the lesser to the greater weight for the users to choose, and after the selection, the system will update the inventory storage table and access record synchronously.

| Brand | Product Name | Weight | | |
|---|---|---|---|---|
| Brand A | Frozen Cabbage Dumplings | 2000 g | | |
| Brand C | Fresh Milk 1.89 L | 1955 g | | |
| Brand A | Pure Fresh Milk 2 L | 2100 g | | |
| | | Original | Remaining | Storage |
| Brand | Product Name | Weight | Weight | Amount |
| Brand A | Juice Flavored | 1365 g | 730 g | 53% |
| | Milk 1300 ml | | | |
| Brand C | Pickles | 555 g | 310 g | 56% |
| Brand A | Frozen Cabbage | 2000 g | 1000 g | 50% |
| | Dumplings | | | |
| Brand B | Beer 330 ml | 370 g | 370 g | 100% |
| Brand E | Eggs | 480 g | 350 g | 73% |
| | Pork Belly Slices | 675 g | 220 g | 33% |
| | Ice Cube | 315 g | 145 g | 46% |
| | Ice Water | 2300 g | 1400 g | 61% |

According to the comparison result of the differences of the weight values, it lists the following menu from the lesser to the greater weight for the users to choose, and after the selection, the system will update the inventory storage table and access record synchronously.

| | Product | Original | Remaining | Storage |
|---|---|---|---|---|
| Brand | Name | Weight | Weight | Amount |
| Brand E | Eggs | 480 g | 350 g | 73% |
| Brand B | Beer 330 ml | 370 g | 370 g | 100% |
| Brand C | Pickles | 555 g | 310 g | 56% |

When the electronic scale measured an increase in the overall weight of the items in the refrigerator, and there are items that have been taken out and yet to be restored back, the embedded system will calculate the increased weight value, in addition to comparing the weight value with the item weight table, so as to find items with similar weights, and at the same time, in accordance with the withdrawal time, list a list of items that have been accessed and not restored in sequence as the following access record for the user to choose. After the selection, the system will update the inventory storage table and access record synchronously.

| | | Take | Take | Record |
|---|---|---|---|---|
| | Product | Out | Out | Deletion |
| Brand | Name | Time | Weight | Time |
| Brand E | Eggs | 2020 Jul. 21 | 350 g | 2020 Jul. 21 |
| | 18:13:21 | | 18:43:21 | |
| Brand B | Beer 330 ml | 2020 Jul. 21 | 370 g | 2020 Jul. 21 |
| | 17:22:03 | | 18:22:03 | |

Another detailed example is provided to further illustrate another method and steps described in FIG. 4. The electronic scale is utilized as a weight measurement device, the embedded system is utilized as an information processing device, and the system is equipped with artificial intelligence voice interactive technology as a way to add, select or edit item information, as well as item inventory table and access record.

When the electronic scale detects an increase of the overall weight in the refrigerator, the embedded system will calculate the increased weight value and ask the user what item s/he has put in.

After the user replied, the system will, based on the item information replied by the user, work out the item weight value, date and time, and etc. and update the inventory storage table and access record.

When the electronic scale detects a decrease of the overall weight in the refrigerator, the embedded system will calculate the decreased weight value, and compare the weight value with the inventory storage table to find out the items with similar weights. Then, the system will ask the user whether any of the items has been removed.

| | | Original | Remaining | Storage |
|---|---|---|---|---|
| Brand | Product Name | Weight | Weight | Amount |
| Brand A | Juice Flavored | 1365 g | 730 g | 53% |
| | Milk 1300 ml | | | |
| Brand C | Pickles | 555 g | 310 g | 56% |
| Brand A | Frozen Cabbage | 2000 g | 1000 g | 50% |
| | Dumplings | | | |
| Brand B | Beer 330 ml | 370 g | 370 g | 100% |
| Brand E | Eggs | 480 g | 350 g | 73% |
| | Pork Belly Slices | 675 g | 220 g | 33% |

After the user replied, the system will, based on the item information replied by the user, work out the item weight value, date and time, and etc. and update the inventory storage table and access record.

Another detailed example is provided to further illustrate another method and steps described in FIG. 4. The electronic scale is utilized as a weight measurement device, the embedded system is utilized as an information processing device, and the system is equipped with artificial intelligence voice interactive technology as a way to add, select or edit item information, as well as item inventory table and access record.

When the electronic scale detects an increase of the overall weight in the refrigerator, the embedded system will calculate the increased weight value and ask the user what item s/he has put in.

After the user replied, the system will, based on the item information replied by the user, work out the item weight value, date and time, and etc. and update the inventory storage table and access record.

When the electronic scale detects a decrease of the overall weight in the refrigerator, the embedded system will calculate the decreased weight value and ask the user what item s/he has taken out.

After the user replied, the system will, based on the item information replied by the user, work out the item weight value, date and time, and etc. and update the inventory storage table and access record.

In summary, utilizing the system and method provided by the present invention can effectively identify items and estimate the dynamic inventory of each of the items.

It will thus be seen that the present invention has been fully and effectively disclosed with the preferred embodiments. The embodiments have been illustrated and described may be subject to change without departure from the principles and spirit of the present invention by any person skilled in the art. Therefore, the protection and scope of the present invention shall follow the appended claims.

What is claimed is:

1. A system for identifying one or more items and an inventory thereof, comprising:
a weight measurement device, which carries and measures an overall weight of the one or more items to provide an overall weight value;
an information processing device, connected with said weight measurement device, wherein said information processing device receives the overall weight value and calculates a weight value of a particular item of the one or more items based on the overall weight obtained before and after an increase or decrease of the particular item; and
means for recording information and weight value of each of the one or more items, wherein said information processing device.

2. The system, as recited in claim 1, wherein said means includes an item weight table, recording an information and weight values of the one or more items, wherein said information processing device compares said item weight table with said weight value of the particular item and utilizes a result to identify the particular item and estimate a stock of the particular item.

3. The system, as recited in claim 2, wherein the information, the weight values, the item inventory, and said item weight table are presented in a form selected from a group consisting of text, picture, image, sound, and combinations thereof, and are adapted to be operated, selected, added, edited, and deleted through means selected from a group consisting of touch, voice, tools, and combinations thereof.

4. The system, as recited in claim 2, wherein said weight measurement device, said information processing device, and said item weight table are provided in a form selected from a group consisting of independently provided, partially integrated with one another, completely integrated with one another, and combinations thereof, wherein said weight measurement device, said information processing device and said item weight table are communicatively connected with one another through means selected from a group consisting of physical lines, Bluetooth, Internet, and combinations thereof.

5. The system, as recited in claim 1, wherein said means includes an inventory storage table to record individual information and weight values of the inventory of the one or more items, wherein said information processing device updates said inventory storage table based on the weight value and an item information of the each of the one or more item while each increase or decrease of each of the one or more items.

6. The system, as recited in claim 5, wherein said information processing device compares the item information or the weight value of each of the one or more items with said inventory storage table to identify the particular item through a result thereof.

7. The system, as recited in claim 5, wherein the item information, the weight values, the inventory, and said inventory storage table are presented in a form selected from a group consisting of text, picture, image, sound, and combinations thereof, and are adapted to be operated, selected, added, edited, and deleted through means selected from the group consisting of touch, voice, tools, and combinations thereof.

8. The system, as recited in claim 5, wherein said weight measurement device, said information processing device and said inventory storage table are provided in a form selected from a group consisting of independently provided, partially integrated with one another, completely integrated with one another, and combinations thereof, wherein said weight measurement device, said information processing device and said inventory storage table are communicatively connected with one another through means selected from a group consisting of physical lines, Bluetooth, Internet, and combinations thereof.

9. The system, as recited in claim 1, wherein said means includes an access record recording an access record of the one or more items, wherein said information processing device synchronously updates an inventory storage state based on changes of the weight value of each of the one or more items and said access record.

10. The system, as recited in claim 9, wherein said information processing device compares an item information or weight value of each of the one or more items with said access record to identify the particular item through a result thereof.

11. The system, as recited in claim 9, wherein said access record, the item weight value, the item information, and the item inventory are presented in a form selected from a group consisting of text, picture, image, sound, and combinations thereof, and are adapted to be operated, selected, added, edited, and deleted through means selected from a group consisting of touch, voice, tools, and combinations thereof.

12. The system, as recited in claim 9, wherein said weight measurement device, said information processing device and said access record are provided in a form selected from a group consisting of independently provided, partially integrated with one another, completely integrated with one another, and combinations thereof, wherein said weight measurement device, said information processing device and said access record are connected with one another through means selected from a group consisting of physical lines, Bluetooth, Internet, and combinations thereof.

13. A method for identifying one or more items and an item inventory, comprising:
(a) measuring an overall weight of the one or more items to provide an overall weight value by a weight measurement device;
(b) receiving the overall weight value and calculating a weight value of a particular item of the one or more items based on the overall weight obtained before and after an increase or decrease of the particular item by an information processing device connected with said weight measurement device; and
(c) recording an information and weight values of the one or more items through an item weight table.

14. The method, as recited in claim 13, further comprising:
(d) comparing said item weight table with said weight value of the particular item and utilizing a result to identify the particular item and estimate a stock of the particular item by said information processing device.

15. The method, as recited in claim 14, wherein the information, the weight values, the item inventory, and said item weight table are presented in a form selected from a group consisting of text, picture, image, sound, and combinations thereof, and are adapted to be operated, selected, added, edited, and deleted through means selected from a group consisting of touch, voice, tools, and combinations thereof, wherein said weight measurement device, said information processing device, and said item weight table are provided in a form selected from a group consisting of independently provided, partially integrated with one another, completely integrated with one another, and combinations thereof, wherein said weight measurement device, said information processing device and said item weight table are communicatively connected with one another through means selected from a group consisting of physical lines, Bluetooth, Internet, and combinations thereof.

16. The method, as recited in claim 13, further comprising:
(d) updating said inventory storage table based on the weight value and an item information of the each of the one or more item while each increase or decrease of each of the one or more items through said information processing device.

17. The method, as recited in claim 16, further comprising:
(e) comparing the item information or the weight value of each of the one or more items with said inventory storage table through said information processing device to identify the particular item through a result thereof.

18. The method, as recited in claim 17, wherein the item information, the weight values, the inventory, and said inventory storage table are presented in a form selected from a group consisting of text, picture, image, sound, and combinations thereof, and are adapted to be operated, selected, added, edited, and deleted through means selected from the group consisting of touch, voice, tools, and combinations thereof, wherein said weight measurement device, said information processing device and said inventory storage table are provided in a form selected from a group consisting of independently provided, partially integrated with one another, completely integrated with one another, and combinations thereof, wherein said weight measurement device, said information processing device and said inventory storage table are communicatively connected with one another through means selected from a group consisting of physical lines, Bluetooth, Internet, and combinations thereof.

19. The method, as recited in claim 13, further comprising:
(d) synchronously updating an inventory storage state based on changes of the weight value of each of the one or more items and an access record of the one or more items recorded by an access record; and
(e) comparing an item information or weight value of each of the one or more items with said access record through said information processing device to identify the particular item through a result thereof.

20. The method, as recited in claim 19, wherein said access record, the item weight value, the item information, and the item inventory are presented in a form selected from a group consisting of text, picture, image, sound, and combinations thereof, and are adapted to be operated, selected, added, edited, and deleted through means selected from a group consisting of touch, voice, tools, and combinations thereof, wherein said weight measurement device, said information processing device and said access record are provided in a form selected from a group consisting of independently provided, partially integrated with one another, completely integrated with one another, and combinations thereof, wherein said weight measurement device, said information processing device and said access record are connected with one another through means selected from a group consisting of physical lines, Bluetooth, Internet, and combinations thereof.
